(19) United States
(12) Patent Application Publication
(10) Pub. No.: US 2025/0216291 A1
(43) Pub. Date: Jul. 3, 2025

(54) INSPECTION DEVICE

(71) Applicant: Siemens Energy Global GmbH & Co. KG, Erlangen (DE)

(72) Inventors: Kai Bergner, Furth (DE); Matthias Nickl, Erlangen (DE)

(73) Assignee: Siemens Energy Global GmbH & Co. KG, Munich, Bayern (DE)

(21) Appl. No.: 18/851,123

(22) PCT Filed: Jan. 20, 2023
(86) PCT No.: PCT/EP2023/051309

§ 371 Date: Sep. 26, 2024

(30) Foreign Application Priority Data
Apr. 5, 2022 (DE) 10 2022 203 384.1

(51) Int. Cl. G01M 13/00; F16L 55/40; F16L 101/30

(52) U.S. Cl. CPC G01M 13/00; F16L 55/40; F16L 2101/30

(57) ABSTRACT

An inspection device is designed to inspect regions of machines, system components, and/or pipeline systems, the regions being inaccessible to persons. At least one drive carriage, and at least one additional carriage which has an inspection unit can be connected to the drive carriage via a joint unit. The drive carriage includes a housing, two wheels which are rotatably held on the housing about at least two rotational axes that are flush with each other, a first electric motor which has a first motor shaft and which rotates the first wheel, and a second electric motor which has a second motor shaft and which rotates the second wheel. Each electric motor rotates the respective wheel via a respective transmission, and the rotational axes extend between the motor shafts of the electric motors.

### CROSS REFERENCE TO RELATED APPLICATIONS

This application is the US National Stage of International Application No. PCT/EP2023/051309 filed 20 Jan. 2023, and claims the benefit thereof, which is incorporated by reference herein in its entirety. The International Application claims the benefit of German Application No. DE 10 2022 203 384.1 filed 5 Apr. 2022.

### FIELD OF INVENTION

The present invention relates to an inspection device that is designed to inspect regions of machines and/or system components and/or pipeline systems, said regions being inaccessible to persons and comprises at least one drive carriage and at least one further carriage which has an inspection unit and can be connected to the drive carriage via a joint unit, wherein the drive carriage comprises a housing, two wheels which are rotatably held on the housing about two rotational axes that are aligned with each other, a first electric motor which has a first motor shaft which rotates the first wheel, and a second electric motor which has a second motor shaft which rotates the second wheel.

### BACKGROUND OF INVENTION

Inspection devices for inspecting regions of machines and/or system components and/or pipeline systems, said regions being inaccessible to persons, are known in the prior art in various embodiments, for example in the form of video endoscopy devices, in which a video lens is pushed into a pipeline to be inspected or into other geometries that are difficult to access using fiberglass-reinforced push rods. However, the use of such video endoscopy devices is only possible in geometries or pipeline systems that do not branch multiple times. Changes in direction are also only possible to a limited extent when inspecting pipelines and other geometries. For example, vertical-horizontal direction changes can hardly be realized. Accordingly, the usability of such video endoscopy devices is severely limited.

Inspection devices in the form of remote-controlled inspection drones are also known, which can be wired or wireless and have powered wheels, chains or the like. An inspection device in the form of such an inspection drone is known, for example, from DE 10 2020 203 453 A1. This inspection drone has at least three carriages, each of which can be equipped with two wheels and which are connected to each other via joint units. By dividing the inspection device into several articulated carriages, a caterpillar-like inspection drone is created which, depending on the type of joint units, is very flexible and can also cope with vertical and horizontal directional changes. Two of the carriages are embodied as drive carriages. The drive carriages are equipped with drives that rotate the respective wheels. According to one embodiment, the drives can be designed as electric hub drives which drive the wheels directly. The hub drives are positioned next to each other in the front-rear direction of the drive carriage in such a way that their motor shafts are aligned with each other. One problem with this design is that the width of the drive carriages is quite large due to the length of motors available on the market, which limits the usability of the inspection device.

### SUMMARY OF INVENTION

Proceeding from this prior art, it is an object of the present invention to create an inspection device having an alternative structure.

To achieve this object, the present invention provides an inspection device of the type mentioned at the outset, which is characterized in that each electric motor rotates the respective wheel via a transmission, and in that the rotational axes extend between the motor shafts of the electric motors. The electric motors are thus positioned one behind the other in the front-rear direction of the drive carriage, so that the width of the drive carriage is significantly smaller than the width of known inspection drones, in particular smaller than the width of the inspection drone described in DE 10 2020 203 453 A1 with the structure described at the outset. Accordingly, the inspection device according to the invention can be used very flexibly. A further advantage of the inspection device according to the invention is that, thanks to the transmissions, the torques that can be transmitted to the wheels can be adjusted, so that the electric motors can be selected much more flexibly not only in terms of their length but also in terms of their torque.

According to one embodiment of the present invention, the transmissions have an identical design, resulting in a structure that can be produced simply and inexpensively.

The transmissions preferably have several gearwheels, in particular exactly two gearwheels each.

The geometries of the gearwheels of each transmission are advantageously selected in such a way that the drive speed is lower than the motor speed, allowing comparatively high torques to be achieved.

According to one embodiment of the present invention, the gearwheels are each attached via a shaft-hub connection, in particular via a form-fit shaft-hub connection, to axles which are rotatably mounted on the housing, are aligned with the rotational axes and on which the wheels are held in a rotationally fixed manner, and to motor shafts of the electric motors. In this way, a very simple and easy-to-assemble structure is achieved.

The axles are preferably positioned in a form-fitting manner between a housing shoulder projecting upwards into the interior of the housing and at least one axle holder placed on the housing shoulder from above and connected to it, in particular detachably connected to it.

According to one embodiment of the present invention, the wheels each have a rim and a magnetic ring held on the rim and forming the running surface of the wheel, said magnetic ring being designed in particular as a neodymium magnetic ring. The magnetic rings ensure that the drive carriage can also be moved easily overhead on metal surfaces. Preferably, the wheels of the other carriages are also provided with corresponding magnetic rings.

The housing of the at least one drive carriage is provided with at least one annular anchor projecting forwards or backwards, which forms part of the joint unit. All other carriages are advantageously provided with two annular anchors projecting outwards, with one anchor projecting forwards and the other anchor projecting backwards.

The joint unit advantageously has an elongate connecting element which has through-holes extending parallel to each other at its opposite end regions, each of which is designed to accommodate an anchor. Accordingly, a very simple and inexpensive design is achieved in which the carriages can be pivoted both horizontally and vertically in relation to each other.

Preferably, the connecting element has two connecting element halves that can be detachably connected to each other, wherein the dividing line between the connecting element halves runs through the through-holes in their direction of extent. The detachable connection is achieved in particular by using at least one fastening screw.

A connecting element half can have at least one connecting pin that engages in a corresponding recess in the other connecting element half when both connecting element halves are assembled. Advantageously, several such connecting pins with corresponding recesses are provided, whereby a very secure connection is achieved.

### BRIEF DESCRIPTION OF THE DRAWINGS

Further features and advantages of the present invention will become clear from the following description with reference to the accompanying drawing, in which

FIG. 1 is a schematic side view of an inspection device according to an embodiment of the present invention;

FIG. 2 is a more detailed perspective view of a drive carriage of the inspection device shown in FIG. 1;

FIG. 3 is a perspective exploded view of the drive carriage shown in FIG. 2;

FIG. 4 is a front view of the drive carriage shown in FIG. 2;

FIG. 5 is a perspective view of a lower housing shell;

FIG. 6 is a perspective view of an upper housing shell;

FIG. 7 is a perspective view of a rim of the drive carriage shown in FIG. 2;

FIG. 8 is a sectional view of the rim shown in FIG. 7;

FIG. 9 is a perspective view of an axle of the drive carriage shown in FIG. 2;

FIG. 10 is a side view of the axle shown in FIG. 6;

FIG. 11 is a perspective view of a first gearwheel of the drive carriage shown in FIG. 2;

FIG. 12 is a perspective view of a second gearwheel of the drive carriage shown in FIG. 2;

FIG. 13 is a perspective view of an axle shown in FIGS. 9 and 10 with a second gearwheel attached to it, which is in meshing engagement with a first gearwheel;

FIG. 14 is a perspective view of the axle holder of the drive carriage shown in FIG. 2;

FIG. 15 is a perspective view of a cable inlet of the drive carriage shown in FIG. 2;

FIG. 16 is a sectional view of the cable inlet shown in FIG. 15;

FIG. 17 is a perspective view of an anchor of the drive carriage shown in FIG. 2;

FIG. 18 is a perspective view of a first connecting element half of a connecting element of the inspection device shown in FIG. 1;

FIG. 19 is a side view of the connecting element halves shown in FIG. 18;

FIG. 20 is a perspective view of a second connecting element half of the connecting element;

FIG. 21 is a side view of the connecting element halves shown in FIG. 20;

FIG. 22 is a perspective view of a stopper of the drive carriage shown in FIG. 22; and

FIG. 23 is a side view of the stopper shown in FIG. 22.

### DETAILED DESCRIPTION OF INVENTION

Like reference numerals in the following refer to like or similarly designed components.

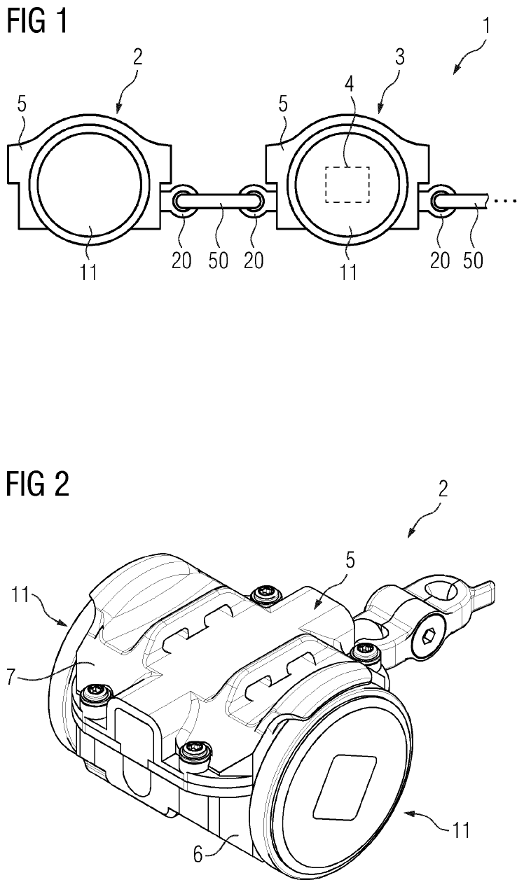

FIG. 1 shows an inspection device 1 according to one embodiment of the present invention, which is designed to inspect regions of machines and/or system components and/or pipeline systems, said regions being inaccessible to persons. The inspection device 1 comprises a plurality of successive carriages 2, 3, of which only two carriages are shown in FIG. 1. The carriages 2, 3 are each detachably attached to each other via joint units. In the present embodiment, the outermost two carriages are designed as drive carriages 2, wherein at least one drive carriage 2 must always be present. At least one of the other carriages 3 comprises an inspection unit 4, only schematically indicated in FIG. 1, for example in the form of a camera, a microscope, an ultrasonic measuring head, an eddy current measuring head or the like. It should be clear that the other carriages 3 can also be equipped with a large number of different inspection units 4, depending on the inspection to be carried out. In principle, it is also possible to equip the drive carriage(s) 2 with inspection units 4.

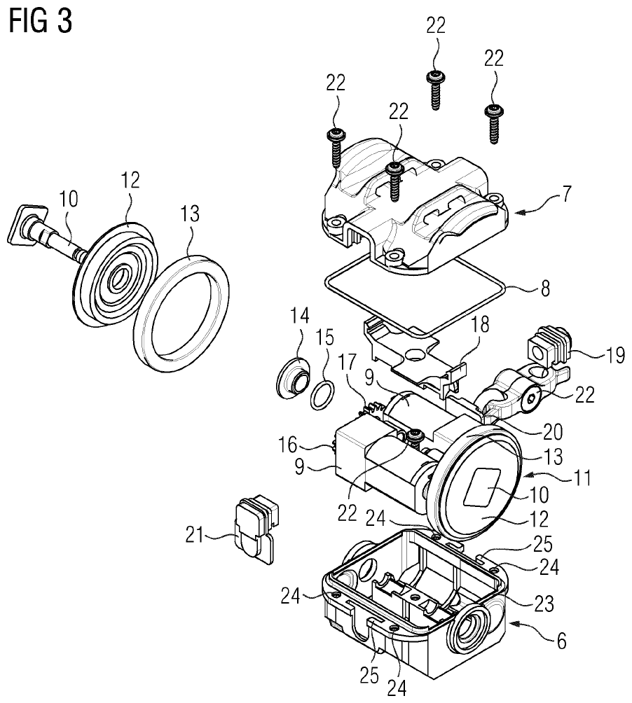

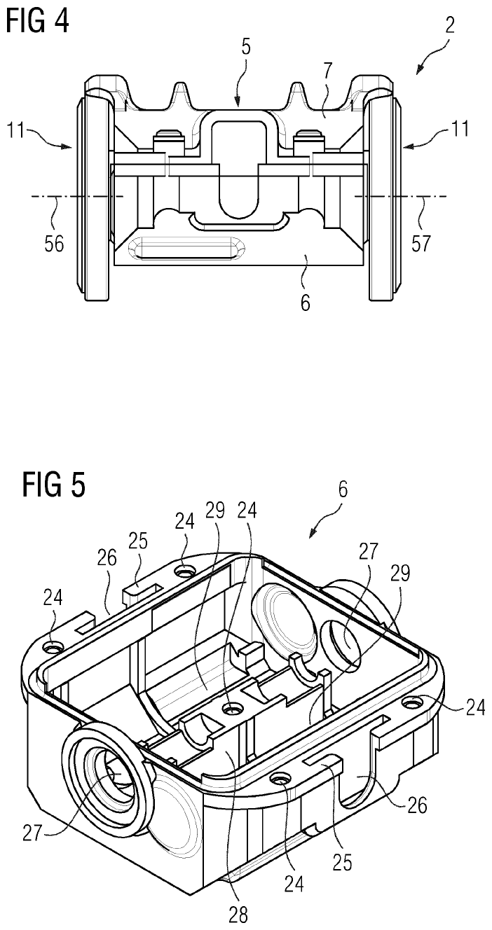

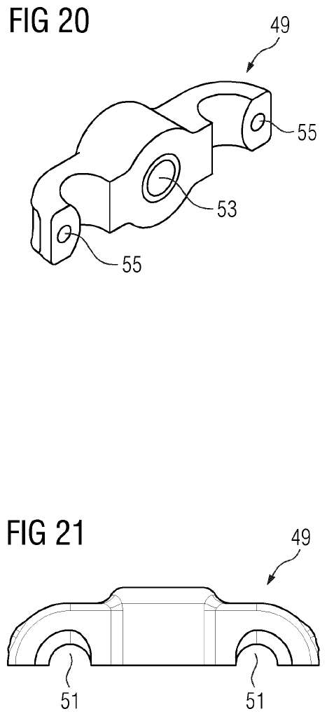

FIGS. 2 to 23 show a drive carriage 2 or components thereof. The drive carriage 2 comprises a housing 5, which is divided into a lower housing shell 6 and an upper housing shell 7, an annular seal 8 to be inserted between the lower housing shell 6 and the upper housing shell 7, two electric motors 9, two axles 10, two wheels 11, which each have a rim 12 and a magnetic ring 13 held on the rim 12 and forming the running surface of the wheel 11, two plain bearings 14, two O-rings 15, two first gearwheels 16 and two second gearwheels 17, an axle holder 18, a bearing inlet 19, an anchor 20, a stopper 21 and a plurality of fastening screws 22.

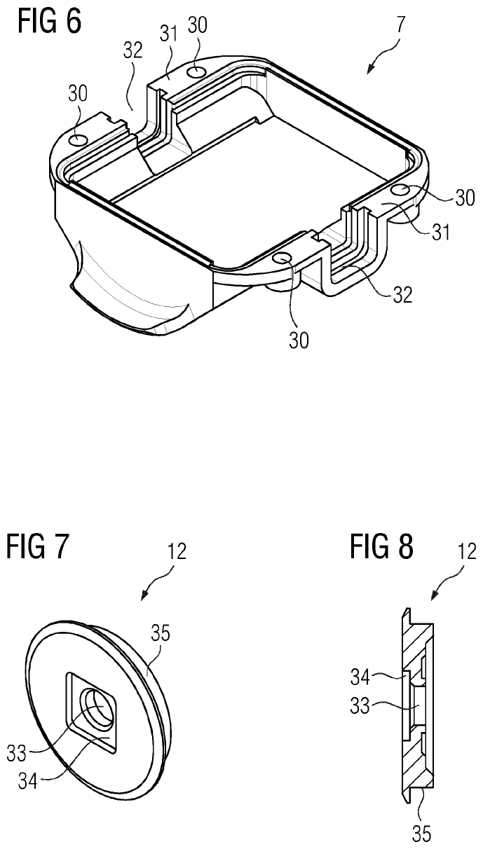

The housing 5 is made of plastic, in this case PA12. The lower housing shell 6, which is shown in FIG. 5, is provided along its upper edge region, which comes into engagement with the upper housing shell 7, with a seal-receiving groove or seal-receiving surface 23 for receiving the seal 8. Fastening flanges 25 provided with threaded holes 24 are arranged opposite each other in the upper region. Starting from these fastening flanges 25, centrally positioned receiving grooves 26 extend downwards from the side walls opposite each other, the geometry of which is selected in such a way that the anchor 20 on the one hand and the stopper 21 on the other hand can be inserted into them from above form-fittingly. Through-holes 27 are formed on the other two sides of the housing, which are aligned with each other and the geometry of which is selected in such a way that the plain bearings 14 with the O-ring 15 mounted on them can be inserted into them from the outside form-fittingly. An upwardly projecting housing shoulder 28 is formed centrally in the interior of the lower housing shell 6 and is designed to form-fittingly receive the axles 10, which are fitted from above and described in greater detail later. A further threaded hole 24 is positioned in the central region of the housing shoulder 28. Recesses 29 are formed in the interior of the lower housing shell 6, in each case adjacent to the housing shoulder 28, to form-fittingly accommodate the two electric motors 9. FIG. 6 shows the associated upper housing shell 7, which also comprises two fastening flanges 31 provided with through-holes 30 on opposite sides in the lower region, which are designed to complement the threaded holes 24 and fastening flanges 25 of the lower housing shell 6, so that the upper housing shell 7 can be placed on the lower housing shell 6 with the seal 8 arranged in between and detachably connected to the latter using fastening screws 22. Starting from the fastening flanges 31, recesses 32 extend upwards, which continue the receiving grooves 26 of the lower housing shell 6 and serve to accommodate the cable inlet 19 on the one hand and the stopper 21 on the other.

FIGS. 7 and 8 show the rim 12, which is preferably made of plastic, in this case PA12. The rim 12 has a through-hole 33 for receiving an axle 10, which through-hole opens out on the outer side into a rectangular recess 34. Furthermore, the rim 12 has a receiving shoulder 35 on its circumferential side, the diameter of which is selected such that one of the magnetic rings 13 can be pushed onto it. The magnetic ring 13 can be secured to the rim 12 in a frictionally engaged manner by means of an interference fit or by using an adhesive.

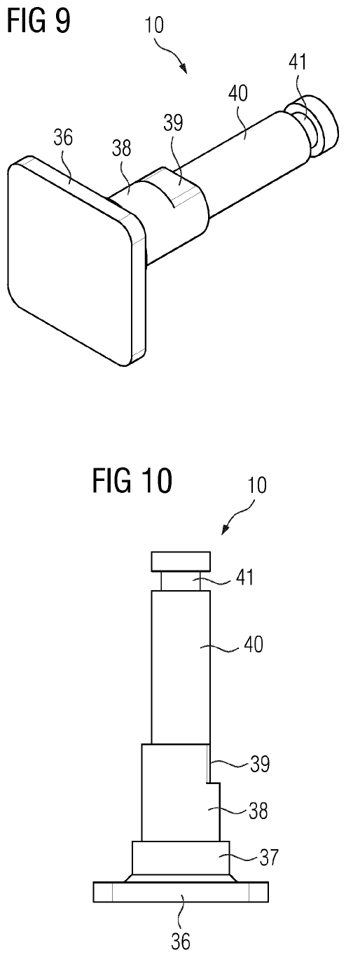

The axle 10 shown in FIGS. 9 and 10 is stepped and preferably made of a metal alloy, in this case X 5 CrNi 18 10. Viewed inwards from the outside, it comprises a rectangular head portion 36, the dimensions of which are selected to correspond to the rectangular recess 34 of the rim 12, a rim-receiving portion 37, the diameter of which is selected to correspond to the through-hole 33 of the rim 12, a bearing-receiving portion 38, the diameter of which is selected to correspond to the inner diameter of the plain bearing 14, a non-circular gearwheel-receiving portion 39 and a fastening portion 40, which is received by the upwardly projecting housing shoulder 28 of the lower housing shell 6. The geometries of the upper surface of the housing shoulder 28 and the fastening portion 40 of the axle 10 are selected in such a way that the fastening portion 40 can be placed onto the housing shoulder 28 form-fittingly. For this purpose, a circumferential groove 41 is formed at the end of the fastening portion 40 in order to prevent displacement of the axle 10 in the axial direction in the assembled state.

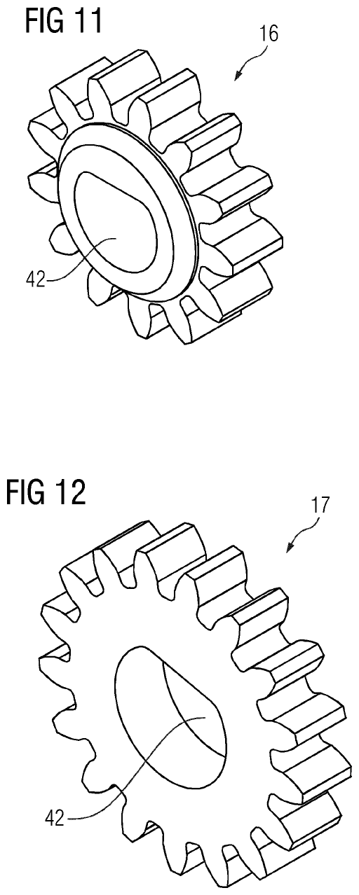

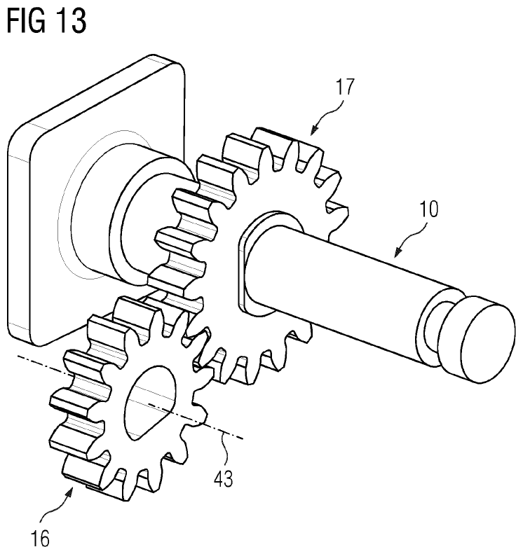

FIGS. 11 and 12 show the first gearwheel 16 on the one hand and the second gearwheel 17 on the other hand, both of which are preferably made of a metal alloy, in the present case CuZn39Pb3. In the embodiment shown, the first gearwheel 16 is smaller than the second gearwheel 17 in relation to the outer diameter and comprises thirteen teeth, while the second gearwheel 17 has seventeen teeth. Both gearwheels 16, 17 are provided with a central through-hole 42 with a non-circular cross-section, wherein the shape of the non-circular cross-section is adapted to the outer contour of the gearwheel-receiving portion 39 of the axle 10 on the one hand and a motor shaft 43 of the electric motors 9, not shown in detail, on the other hand in such a way that the first gearwheel 16 can be fitted onto the motor shaft 43 and the second gearwheel 17 onto the axle 10 form-fittingly. FIG. 13 shows an example of an axle 10 with a second gearwheel 17 arranged on it, which meshes with the first gearwheel 16, which is fitted onto the motor shaft 43 indicated in this figure by the dashed line.

FIG. 14 shows the axle holder 18, the lower side of which is complementary to the upper side of the housing shoulder 28 formed on the lower housing shell 6 and which is provided with a through-hole 44, which is positioned in alignment with the threaded hole 24 of the housing shoulder 28. On the upper side, the axle holder 18 has two outwardly projecting hold-down devices 45 arranged opposite one another, which, when mounted, press from above on the electric motors 9 inserted into the receiving recesses 29 of the lower housing shell 6 and secure them in their position. The axle holder 18 is preferably made of plastic, in this case PA12.

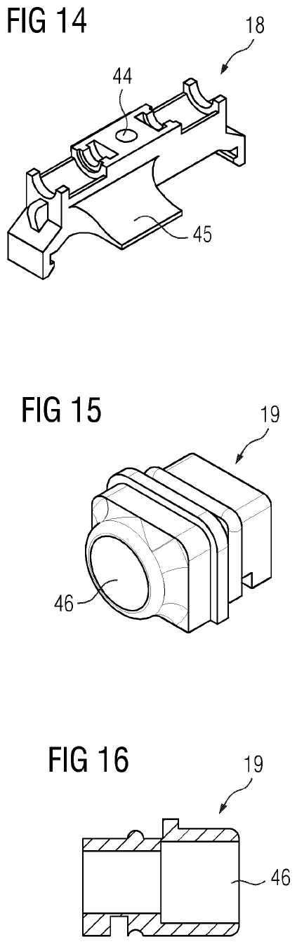

FIG. 15 shows the cable inlet 19, which is preferably made of a thermoplastic material, in this case TPU (thermoplastic polyurethane). It is designed with a cylindrical through-hole 46, through which a cable can be fed. The geometry of the outside of the cable inlet 19 is selected such that the cable inlet 19 can be inserted form-fittingly into one of the lateral recesses 32 of the upper housing shell 7 and sits sealingly on the anchor 20 inserted into the receiving groove 26 of the lower housing shell 6 arranged underneath.

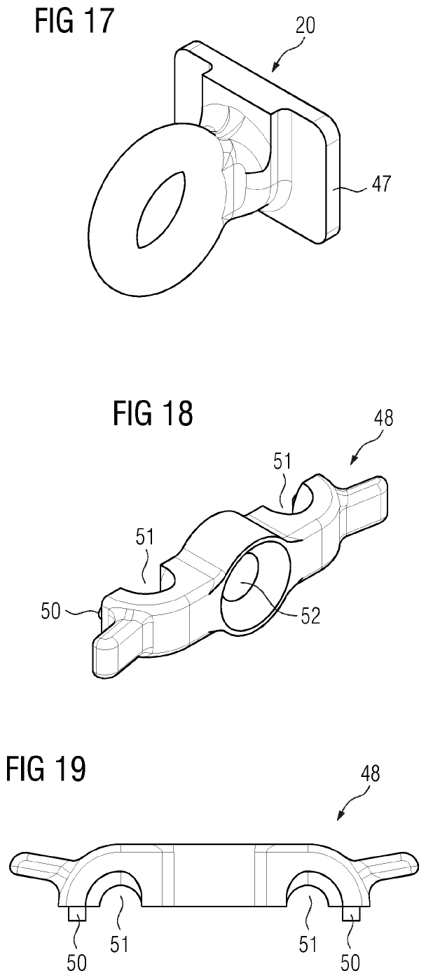

FIG. 17 shows the ring-shaped anchor 20 with a plate-like fastening portion 47, the dimensions of which are selected in such a way that it can be inserted form-fittingly from above into one of the receiving grooves 26 of the lower housing shell 6. The anchor 20 is preferably made of plastic, in this case PA12.

FIGS. 18 to 21 show two connecting element halves 48 and 49 of the connecting element 50 shown schematically in FIG. 1, which is preferably made of plastic, in this case PA12. The connecting element 50 is of elongate form and has two through-holes 51 extending parallel to each other at its opposite end regions, each of which is designed to receive an anchor 20. The dividing line between the two connecting element halves 48, 49 is selected such that it runs through the through-holes 51 in the direction in which they extend. The first connecting element half 48 is provided with a through-hole 52 in the center, which points in the direction of the second connecting element half 49. The second connecting element half 49 is provided with a threaded hole 53 aligned with the through-hole 52, so that both connecting element halves 48, 49 can be connected with a fastening screw 22. In addition, the first connecting element half 48 is provided with two connecting pins 54 projecting in the direction of the second connecting element half 49, which engage in corresponding recesses 55 of the second connecting element half 49 when both connecting element halves 48, 49 are in the assembled state.

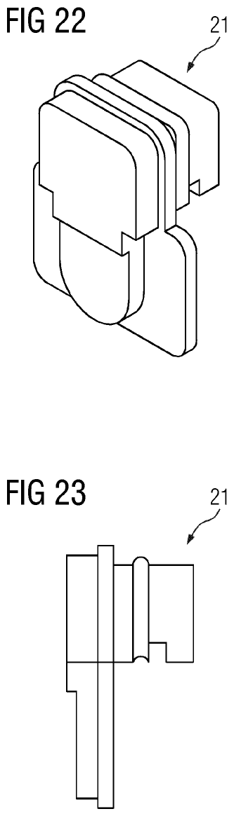

FIGS. 22 and 23 show the stopper 21, which can be inserted sealingly into the receiving groove 26 of the lower housing shell 6 and into the associated recess 32 of the upper housing shell 7 and, when inserted, prevents moisture from entering the interior of the housing 5. The stopper 21 is preferably made of a thermoplastic material, in this case TPU.

To assemble a drive carriage 2, the electric motors 9 with the first gearwheels 16 mounted on their motor shafts 43, forming form-fit shaft-hub connections, are first inserted into the receiving recesses 29 of the lower housing shell 6 from above in such a way that the electric motors 9 are received form-fittingly in the receiving recesses 29 and the first gearwheels 16 are arranged on opposite sides.

In a second step, the magnetic rings 13 are slid onto the associated mounting shoulders 35 of the rims 12. The axle 10 is then inserted through the through-hole 33 of the corresponding rim 12 until the rectangular head portion 36 of the axle 10 is form-fittingly received in the rectangular recess 34 of the rim 12. The plain bearing 14 with the O-ring 15 mounted on it is then pushed onto the bearing-receiving portion 38 of the axle 10 from the other side. In a further step, the axles 10 are inserted from the outside into the through-holes 27 of the lower housing shell 6, wherein the second gearwheels 17 are positioned on the respective gearwheel-receiving portions 39 of the axles 6, forming a form-fit shaft-hub connection. The second gearwheels 17 are brought into engagement with the first gearwheels 16 in the interior of the housing 5 and the fastening portions 40 of the axles 10 are form-fittingly received on the upper side of the upwardly projecting housing shoulder 28 of the lower housing shell 6.

The axle holder 18 is now placed on the upwardly projecting housing shoulder 28 of the lower housing shell 6 and screwed to it using a fastening screw 22. In this state, the axles 10 are held firmly between the housing shoulder 28 and the axle holder 18. Furthermore, the hold-down devices 45 press on the electric motors 9 from above so that these are also securely positioned.

The seal 8 is then placed on the lower housing shell 6. In addition, the anchor 20 and the stopper 21 are inserted into the respective receiving grooves 26 of the lower housing shell 6 from above.

In a further step, the cable inlet 19 is inserted into the recess 32 of the upper housing shell 7 that is to be positioned above the anchor 20. The upper housing shell 7 is then placed on the lower housing shell 6, wherein the cable inlet 19 presses sealingly against the fastening portion 47 of the anchor 20 and the stopper 21 is received sealingly in the opposite recess 32 of the upper housing shell 7. In a final step, the upper housing shell 7 is screwed to the lower housing shell 6 using fastening screws 22.

In the assembled state, the wheels 11 can now be driven by a motor using the electric motors 9 to rotate about their rotational axes 56, 57, which are arranged in alignment with one another, via the transmissions formed by a first gearwheel 16 and a second gearwheel 17 in each case. The rotational axes 56, 57 extend between the motor shafts 43 of the electric motors 9.

In order to couple the drive carriage 2 to another carriage 3, the two connecting element halves 48, 49 are pushed onto each other in such a way that the ring-shaped anchors 20 of the two carriages 2, 3 to be connected are accommodated in the through-holes of the connecting element. The connecting element halves 48, 49 are then screwed together. The carriages 2, 3 can now be pivoted both horizontally and vertically relative to each other.

The inspection device 1 according to the invention is characterized in particular by the very compact design of its drive carriages 2 and the modular structure. Thanks to the detachable connection of the individual carriages 2, 3, these can be combined with each other in any order and number. The inspection device 1 can also be assembled as required with regard to the inspection equipment 4, depending on the inspection to be carried out. If a carriage 2, 3 or an inspection unit 4 fails during an inspection, the corresponding carriages 2, 3 can easily be replaced on site with a new intact carriage 2, 3. Preferably, the carriages 3 have basically the same structure as the carriages 2, except that the carriages 3 are not equipped with electric motors 9 and transmissions. In this way, the manufacturing costs of the inspection device 1 can be significantly reduced.

Although the invention has been illustrated and described in detail by the preferred exemplary embodiment, the invention is not limited by the disclosed examples and other variations may be derived by a person skilled in the art without departing from the scope of protection of the invention.

1. An inspection device that is adapted to inspect regions of machines and/or system components and/or pipeline systems, said regions being inaccessible to persons, comprising:
at least one drive carriage and at least one further carriage which has an inspection unit and connectable to the drive carriage via a joint unit,
wherein the drive carriage comprises a housing, two wheels which are held on the housing so as to be rotatable about two rotational axes aligned with each other, a first electric motor which has a first motor shaft and which rotates a first wheel, and a second electric motor which has a second motor shaft and which rotates a second wheel,
wherein each electric motor rotates the respective wheel in rotation via a transmission, and wherein the rotational axes extend between the first and second motor shafts of the electric motors.

2. The inspection device as claimed in claim 1,
wherein the transmissions are of identical design.

3. The inspection device as claimed in claim 1- or 2,
wherein the transmissions have a plurality of gearwheels.

4. The inspection device as claimed in claim 3,
wherein geometries of the gearwheels of each transmission are selected in such a way that the drive speed is lower than the motor speed.

5. The inspection device as claimed in claim 3,
wherein the gearwheels are each fastened via a shaft-hub connection to axles which are rotatably mounted on the housing, are aligned with the rotational axes and on which the wheels are held in a rotationally fixed manner, and to the first and second motor shafts of the electric motors.

6. The inspection device as claimed in claim 5,
wherein the axles are positioned form-fittingly between a housing shoulder projecting upwards into an interior of the housing and at least one axle holder placed on the housing shoulder from above and connected thereto.

7. The inspection device as claimed in claim 1,
wherein the wheels each have a rim and a magnetic ring held on the rim and forming a running surface of the wheel.

8. The inspection device as claimed in claim 1,
wherein at least one annular anchor projecting outwards to a front or a rear is provided on the housing and forms part of the joint unit.

9. The inspection device as claimed in claim 8,
wherein the joint unit has an elongate connecting element which, at its opposite end regions, has through-holes which extend parallel to one another and are each adapted to receive an anchor.

10. The inspection device as claimed in claim 9,
wherein the connecting element has two connecting element halves which are detachably connected to one another, wherein a dividing line between the connecting element halves runs through the through-holes in their direction of extent.

11. The inspection device as claimed in claim 10,
wherein one connecting element half has at least one connecting pin which, in an assembled state of both connecting element halves, engages in a corresponding recess of the other connecting element half.

12. The inspection device as claimed in claim 3,
wherein the transmissions have exactly two gearwheels in each case.

13. The inspection device as claimed in claim 5,
wherein the gearwheels are each fastened via a shaft-hub connection via a form-fitting shaft-hub connection to the axles.

14. The inspection device as claimed in claim 6,
wherein the axles are detachably connected.
